(19) United States
(12) Patent Application Publication
(10) Pub. No.: US 2003/0196097 A1
(43) Pub. Date: Oct. 16, 2003

(54) System and method for airport security employing identity validation

(76) Inventors: Jason A. Korosec, Chesterland, OH (US); David J. Akers, University Heights, OH (US); Lysianne Buie, Toronto (CA); Donald Haus, Chardon, OH (US); Melissa T. Hazard, Olmsted Falls, OH (US); Michael Hsu, Highland Heights, OH (US); Eric Seed, St. Paul, MN (US)

Correspondence Address: Jeffrey R. Sadlowski, Amin & Turocy, LLP, National City Center, 1900 E. 9th Street, 24th Floor, Cleveland, OH, 44114, US

(21) Appl. No.: 10/452,266

(22) Filed: Jun. 2, 2003

Related U.S. Application Data
(63) Continuation-in-part of application No. 10/242,150, filed on Sep. 12, 2002.
(60) Provisional application No. 60/323,475, filed on Sep. 19, 2001.

(51) Int. Cl. H04L 9/00

(52) U.S. Cl. 713/185

(57) ABSTRACT

A system and method for airport security employing identity validation and/or verification is provided. The invention includes a first identification input component, a second identification input component, a security output component, and, optionally an identity transaction engine component. The system facilitates airport security by having a person attempting to engage in air travel present identification on at least two occasions via the first identification input component and the second identification input component. The first identification input component initiates identification validation utilizing an identity transaction engine component. The second identification input component facilitates identification of the person so that security information obtained via the identity transaction engine component can be provided to the security output component.

### CROSS-REFERENCE TO RELATED APPLICATIONS

This application is a continuation-in-part of co-pending U.S. Utility application Ser. No. 10/242,150 which was filed Sep. 12, 2002, entitled SYSTEM AND METHOD FOR IDENTITY VALIDATION FOR A REGULATED TRANSACTION, which claims priority to U.S. Provisional Application Serial No. 60/323,475 entitled SYSTEM AND METHOD FOR IDENTITY VALIDATION and filed on Sep. 19, 2001, the entire disclosures of which are incorporated herein by reference.

### TECHNICAL FIELD

The present invention relates to the field of systems and methods for identity verification and/or validation for airport security.

### BACKGROUND OF THE INVENTION

Each day, thousands of people travel by air. As demonstrated by the recent hijacking of commercial aircraft and the tragic consequences resulting therefrom, there is a need for systems and methods that increase security measures related to airport(s). However, the flying public has generally been inconvenienced with increased security measures, for example, long lines at ticket counter(s) and/or security check point(s).

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. Its sole purpose is to present some concepts of the invention in a simplified form as a prelude to the more detailed description that is presented later.

The present invention relates to a system and method for airport security employing identity validation and/or verification. According to an aspect of the present invention, an airport security system having a first identification input component, a second identification input component, a security output component, and, optionally an identity transaction engine component is provided. The system facilitates airport security by having a person attempting to engage in air travel present identification on at least two occasions via the first identification input component and the second identification input component. The first identification input component initiates identification validation utilizing the identity transaction engine component. The second identification input component facilitates identification of the person so that security information obtained via the identity transaction engine component can be provided to the security output component.

The first identification input component receives information associated with a person attempting to engage in air travel and provides at least some of the information received to the identity transaction engine component. The first identification input component can receive information from input device(s), for example, a card reader, a magnetic card reader, keyboard, a touch screen device, a DNA fingerprint analyzer, a DNA profile analyzer, an optical character reader (OCR), an iris scanner, a retinal scanner, a thumb print reader, a digital camera, a pointing device, such as a mouse, a microphone, an IR remote control, a joystick, a game pad, a personal digital assistant (PDA), a pager, a text messaging device, a smart card reader or the like.

The identity transaction engine component can search data store(s) in order to validate identity of the person attempting to engage in air travel based, at least in part, upon information obtained from the first identification input component. For example, the identity transaction engine component can utilize the person's date of birth, name, Social Security Number, identifier (e.g., identification number), address, age, DNA fingerprint, DNA profile, ethnicity, citizenship, religious affiliation, political affiliation, biometric data, height, weight, health status, gender, registration status with Selective Service, history of conviction of felony and/or inclusion on list(s) of governmental agencies and/or private groups in order to determine whether the person should be permitted to engage in air travel.

The second identification input component receives at least some of the information associated with the person attempting to engage in air travel (e.g., from the person seeking to engage in air travel)., The second identification input component provides at least some of the information received to the identity transaction engine component. Thereafter, the identity transaction engine component provides security information associated with the person to the security output component.

The security output component provides security information associated with the person attempting to engage in air travel (e.g., to airport security personnel). The security information can be based, at least in part, upon information received from the identity transaction engine component and/or information received via the second identification input component. The security output component can include output device(s), for example, a telephone, a computer system, a light bar, an audible alarm, a touch screen device, a computer monitor, a television screen, a printer, a personal digital assistant, a wireless telephone display and/or speaker(s). The security information can provide information and/or instruction(s) to airport personnel, for example, to detain the person, conduct a thorough search of the person and/or person is to be presumed armed and dangerous.

The security output component can further forward information (e.g., data packet(s)) to other systems (not shown) to provide security information (e.g., including decision(s) of the identity transaction engine component). For example, these other systems can utilize the information provided (e.g., via data packet(s)) to take some predefined further action (e.g., remove passenger baggage from an aircraft).

The identity transaction engine component utilizes the information received from the first identification input component to search one or more data store(s) in order to validate the identity of the person attempting to engage in air travel and/or their suitability for engaging in air travel. The identity transaction engine component generates security information associated with the person based, at least in part, upon the information received from the first identification input component and information stored in the data store(s). For example, the identity transaction engine component can at least temporarily store and/or cache security information associated with a plurality of individuals attempting to engage in air travel.

Thus, the first identification input component can initiate generation of security information by the identity transaction engine component in a non-obtrusive manner since processing of the identity transaction engine component can occur while the person is engaging is other travel and/or non-travel-related activities (e.g., obtaining a boarding pass, purchasing food and/or beverage item(s), shopping, conversing with fellow traveler(s), walking in airport and/or waiting in an airport security queue). The identity transaction engine component can store, at least temporarily, the security information until the person presents himself/herself at the security checkpoint.

Thereafter, information associated with the person attempting to engage in air travel is received by the second identification input component. The information can be based upon the same, similar and/or different identification received by the first identification input component. The second identification input component can provide at least some of the information received to the identity transaction engine component (e.g., name of person). Based, at least in part, upon the information received from the second identification input component, the identity transaction component can provide security information associated with the person to the security output component (e.g., cleared, not cleared, high alert, processing, etc.).

Accordingly, security information can seamlessly be generated by the identity transaction engine component for a plurality of people seeking to engage in air travel. The security information can be generated with minimal intrusion for the prospective air travelers and facilitates increased airport security.

Another aspect of the present invention provides for an airport security system having a first identification input component, a second identification input component, a local identification component and a security output component. The system can further include an identity transaction engine component and/or data store(s).

The system facilitates airport security in a distributed environment. The local identification component can gather information associated with person(s) attempting to engage in air travel via the first identification input component. The local identification component can provide the information to an identity transaction engine component (not shown), for example, via a secure satellite link. The identity transaction engine component can then provide security information associated with the person(s) to the local identification component which can be provided to the security output component, at an appropriate time (e.g., when a person is participating in a security check). Thus, the local identification component initiates identification validation by the identity transaction engine component based, at least in part, upon information obtained by the first identification input component. The second identification input component facilitates identification of the person so that security information obtained via the identity transaction engine component can be provided to the security output component.

Yet another aspect of the present invention provides for a security system having at least one identification input component, a security component having an occupant data store, and, a security output component having output device(s). Optionally, the system can include an identity transaction engine component.

The system facilitates security by identifying person(s) located within a secured area. The system can store identification information associated with person(s) located within the secured area in the occupant data store. For example, the security component can determine security risk(s) associated with person(s) located within the secured area, change(s) associated with person(s) located within the secured area and/or logical inconsistency(ies) (e.g., person(s) exiting system without having information stored in the occupant data store and/or person(s) entering the system without having exited at an appropriate time).The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 is a schematic block diagram of an airport security system in accordance with an aspect of the present invention.

FIG. 2 is a schematic block diagram of an airport security system in accordance with an aspect of the present invention.

FIG. 3 is a schematic block diagram of an airport security system in accordance with an aspect of the present invention.

FIG. 4 is a schematic block diagram of an airport security system in accordance with an aspect of the present invention.

FIG. 5 is a diagram of an exemplary output device in accordance with an aspect of the present invention.

FIG. 6 is a diagram of an exemplary output device in accordance with an aspect of the present invention.

FIG. 7 is a diagram of an exemplary output device in accordance with an aspect of the present invention.

FIG. 8 is a diagram of an exemplary user interface in accordance with an aspect of the present invention.

FIG. 9 is block diagram of an output device in accordance with an aspect of the present invention.

FIG. 10 is a block diagram of a security system in accordance with an aspect of the present invention.

FIG. 11 is a block diagram of a secured area in accordance with an aspect of the present invention.

FIG. 12 is a flow chart illustrating a methodology for providing airport security in accordance with an aspect of the present invention.

FIG. 13 is a flow chart illustrating a methodology for providing airport security in accordance with an aspect of the present invention.

FIG. 14 is a flow chart illustrating a methodology for providing security in accordance with an aspect of the present invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident to one skilled in the art that the present invention may be practiced without these specific details. In other instances, well-known structures and devices are shown in block diagram form in order to facilitate description of the present invention.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component.

Further, “security information” is intended to refer to security-related information associated with air traveler(s). For example, security information can include conclusory information such as cleared for air travel, not cleared for air travel, detain individual, etc. Additionally and/or alternatively, security information can include information associated with a security risk assessment, for example, a probability and/or likelihood that an air traveler is a security risk (e.g., numerical (75%) and/or range-based (e.g., low, medium, high)). Security information can further include identifying information associated with air traveler(s), for example, digitized fingerprint, digital facial image, digital voice print, etc.

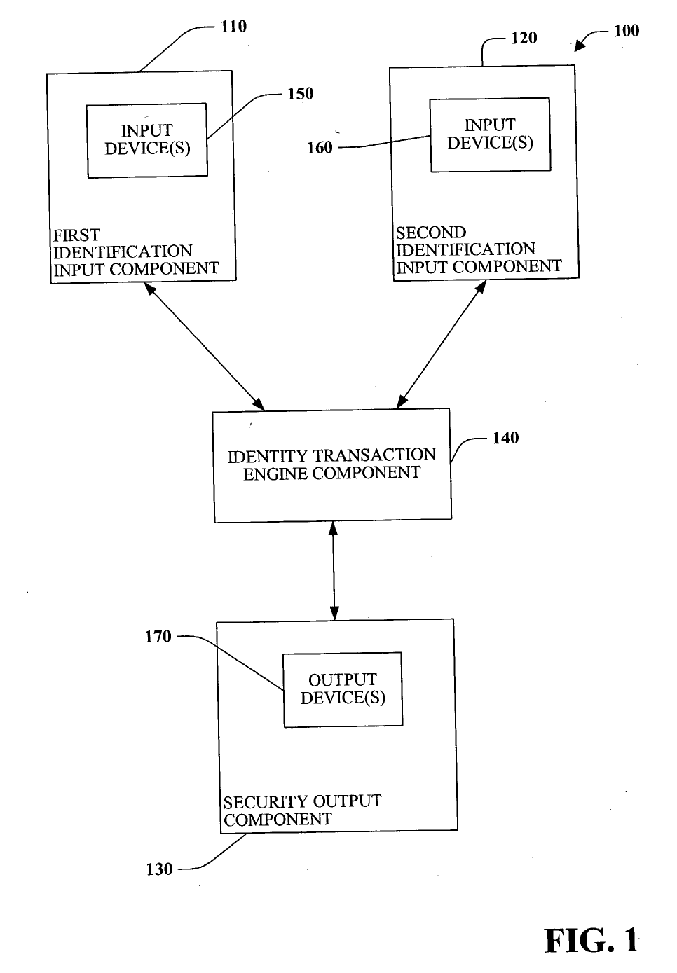

Referring to FIG. 1, an airport security system 100 in accordance with an aspect of the present invention is illustrated. The system 100 includes a first identification input component 110, a second identification input component 120 and a security output component 130. Optionally, the system 100 can further include an identity transaction engine component 140.

The system 100 facilitates airport security by having a person attempting to engage in air travel present identification on at least two occasions via the first identification input component 110 and the second identification input component 120. The first identification input component 110 initiates identification validation utilizing an identity transaction engine component 140. The second identification input component 120 facilitates identification of the person so that security information obtained via the identity transaction engine component 140 can be provided to the security output component 130.

The first identification input component 110 receives information associated with a person attempting to engage in air travel and provides at least some of the information received to the identity transaction engine component 140. The first identification input component 110 can receive information from input device(s) 150, for example, a card reader, a magnetic card reader, keyboard, a touch screen device, a DNA fingerprint analyzer, a DNA profile analyzer, an optical character reader (OCR), an iris scanner, a retinal scanner, a thumb print reader, a digital camera, a pointing device, such as a mouse, a microphone, an IR remote control, a joystick, a game pad, a personal digital assistant (PDA), a pager, a text messaging device, a smart card reader, electronic ticket machine or the like. The first identification input component 110 can provide information to the identity transaction engine component 140, for example, identifying the person attempting to engage in air travel.

In one example, the first identification input component 110 includes an electronic ticket (E-ticket) machine. E-ticket machine(s) generally require a form of identification (e.g., driver's license, identification card and/or credit card). Information associated with a person attempting to engage in air travel can be captured via the E-ticket machine and provided to the identity transaction engine component 140. Thus, in the time period during which the person is traveling from the E-ticket machine to a security checkpoint, the identity transaction engine component 140 can search data store(s) and generate security information associated with the person.

In another example, the first identification input component 110 receives information from a boarding pass, a governmental identification card, a private identification card and/or an employment identification card.

Additionally and/or alternatively, input device(s) 150 can be located at curbside check-in, ticket counter check-in, an entrance to an airport facility, at customs clearing, security check point and/or at a gate.

The identity transaction engine component 140 can search data store(s) in order to validate identity of the person attempting to engage in air travel and/or suitability of the person to engage in air travel based, at least in part, upon information obtained from the first identification input component 110. For example, the identity transaction engine component 140 can utilize the person's date of birth, name, Social Security Number, identifier (e.g., identification number), address, age, DNA fingerprint, DNA profile, ethnicity, citizenship, religious affiliation, political affiliation, biometric data, height, weight, health status, gender, registration status with Selective Service, history of conviction of felony and/or inclusion on list(s) of governmental agencies and/or private groups in order to determine whether the person should be permitted to engage in air travel.

The identity transaction engine component 140 can communicate with remote system(s) (not shown) (e.g., data store(s), database(s) and/or data storage system(s)). For example, the identity transaction engine component 140 can search the remote system(s) (not shown) based, at least in part, upon information associated with the person's identity (e.g., name, address, social security number, identification number, passport number, selective service number, voter identification number and/or date of birth) in order to validate and/or verify identity and possession of attribute(s) to engage in air travel.

The identity transaction engine component 140 can be coupled to the first identification input component 110 and/or the second identification input component 120 utilizing, for example, a telephone connection, a network connection, an extranet, an intranet, the Internet, a satellite link, a wireless communication link, a serial communication link and/or a parallel communication link. Information exchanged between the identity transaction engine component 140 and the first identification input component 110, the second identification input component 120 and/or the security output component 130 can be performed in a variety of secure and/or encrypted manners.

The second identification input component 120 receives at least some of the information associated with the person attempting to engage in air travel. The second identification input component 120 can include input device(s) 160, for example, a card reader, a magnetic card reader, keyboard, a touch screen device, a DNA fingerprint analyzer, a DNA profile analyzer, an optical character reader (OCR), an iris scanner, a retinal scanner, a thumb print reader, a digital camera, a pointing device, such as a mouse, a microphone, an IR remote control, a joystick, a game pad, a personal digital assistant (PDA), a pager, a text messaging device, a smart card reader, an electronic ticket machine or the like. In one example, the information received by the second identification input component 120 is from the same identification source as the first identification input component 110 (e.g., from a registered traveler identification card, a driver's license, passport, government identification card, employee identification card, boarding pass and/or temporary identification). In another example, the information received by the second identification input component 120 receives is from a different identification source as the first identification input component 110 (e.g., driver's license used by at first identification input component 110 and boarding pass used by second identification input component 120).

The second identification input component 120 provides at least some of the information received to the identity transaction engine component 140. Thereafter, the identity transaction engine component 140 provides security information associated with the person to the security output component 130.

In one example, the second identification input component 120 includes input device(s) 160 physically located before a person places carry-on belonging(s) onto a conveyor belt. In another example, the second identification input component 120 includes input device(s) 160 physically located after a person places carry-on belonging(s) onto a conveyor belt, but before proceeding through a metal detector (e.g., second identification input component 120 physically located before person proceeds through metal detector and/or x-ray machine). In a third example, the second identification input component 120 includes input device(s) 160 physically located after a person has proceeded through a metal detector, but before the person retrieves the person's carry-on belonging(s). In yet a fourth example, the second identification input component 120 includes input device(s) 160 physically located after a person has retrieved the person's carry-on belonging(s).

The security output component 130 provides security information associated with the person attempting to engage in air travel (e.g., to airport security personnel) received from the identity transaction engine component. The security output component 130 can include output device(s) 170, for example, a telephone, a computer system, a light bar, an audible alarm, a touch screen device, a computer monitor, a television screen, a printer, a personal digital assistant, a wireless telephone display and/or speaker(s). The security information can provide information and/or instruction(s) to airport personnel, for example, detain person, conduct thorough search of person and/or person is to be presumed armed and dangerous.

The security output component 130 can further forward information (e.g., data packet(s)) to other systems (not shown) to provide security information (e.g., including decision(s) of the identity transaction engine component 140). For example, these other systems can utilize the information provided (e.g., via data packet(s)) to take some predefined further action (e.g., remove passenger baggage from an aircraft).

In one example, information associated with a person attempting to engage in air travel is received by the first identification input component 110. For example, the information can be based, at least in part, upon a driver's license, identification card and/or passport input via a magnetic card reader at a ticket counter and/or an airport entrance. At least some of the information is then sent to the identity transaction engine component 140.

The identity transaction engine component 140 utilizes the information received from the first identification input component 110 to search one or more data store(s) in order to validate identity of the person attempting to engage in air travel and/or their suitability for engaging in air travel. In one example, the identity transaction engine component 140 utilizes information retrieved from one or more data store(s) to further search yet other data store(s) 140 in order to validate identity of the person attempting to engage in air travel and/or their suitability for engaging in air travel. For example, specific information (e.g., social security number) can be derived from one data store, received by the identity transaction engine component 140 and utilized to search yet other data store(s) (e.g., based on enriched data).

The identity transaction engine component 140 generates security information associated with the person based, at least in part, upon the information received from the first identification input component 110 and information stored in the data store(s). For example, the identity transaction engine component 140 can at least temporarily store and/or cache security information associated with a plurality of individuals attempting to engage in air travel.

Thus, the first identification input component 110 can initiate generation of security information by the identity transaction engine component 140 in a non-obtrusive manner since processing of the identity transaction engine component 140 can occur while the person is engaging in other-travel and/or non-travel-related activities (e.g., obtaining a boarding pass, purchasing food and/or beverage item(s), shopping, conversing with fellow traveler(s), walking in airport and/or waiting in an airport security queue). The identity transaction engine component 140 can store, at least temporarily, the security information until the person presents himself/herself at a security checkpoint, gate, ticket counter, law enforcement center etc.

Thereafter, information associated with the person attempting to engage in air travel is received by the second identification input component 120. The information can be based upon the same, similar and/or different identification received by the first identification input component 110. For example, the second identification input component 120 can include a magnetic card reader be located in close proximity to a security metal detector. The second identification input component 120 can provide at least some of the information received to the identity transaction engine component 140 (e.g., name of person). Based, at least in part, upon the information received from the second identification input component 120, the identity transaction component 140 can provide security information associated with the person to the security output component 130 (e.g., cleared, not cleared, high alert, processing, etc.).

Accordingly, security information can seamlessly be generated by the identity transaction engine component 140 for a plurality of people seeking to engage in air travel. The security information can be generated with minimal intrusion for prospective air travelers and facilitates increased airport security.

While the system 100 has been described with regard to airport security, the system 100 can be employed to facilitate security of other types of physical area(s). For example, the system 100 can be employed to secure an airport concourse, an airport terminal, an airport facility (e.g., tarmac and interior), an airport (e.g., physical grounds and interior), building, country, city, county, military base, embassy, cruise ship, hospital, power plant, nuclear facility, train, bridge and/or tunnel in accordance with an aspect of the present invention.

It is to be appreciated that the system 100, the first identification input component 110, the second identification input component 120, the security output component 130 and/or the identity transaction engine component 140 can be component(s) as that term is defined herein.

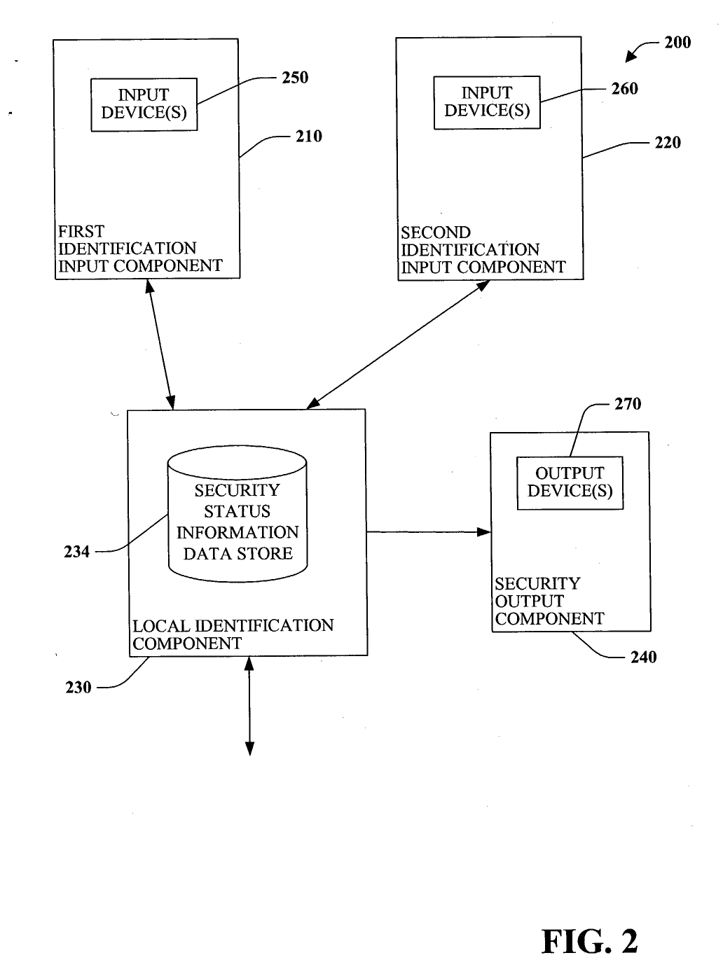

Turning next to FIG. 2, an airport security system 200 in accordance with an aspect of the present invention is illustrated. The system 200 includes a first identification input component 210, a second identification input component 220, a local identification component 230 and a security output component 240.

The system 200 facilitates airport security in a distributed environment. The local identification component can gather information associated with person(s) attempting to engage in air travel via the first identification input component 210. The local identification component 230 can provide the information to an identity transaction engine component (not shown), for example, via a secure satellite link. The identity transaction engine component can then provide security information associated with the person(s) to the local identification component 230 which can be provided to the security output component 240, at an appropriate time (e.g., when a person is participating in a security check). Thus, the local identification component 230 initiates identification validation by the identity transaction engine component based, at least in part, upon information obtained by the first identification input component 210. The second identification input component 220 facilitates identification of the person so that security information obtained via the identity transaction engine component can be provided to the security output component.

The first identification input component 210 receives information associated with a person attempting to engage in air travel and provides at least some of the information received to the local identification component 230. The first identification input component 210 can receive information from input device(s) 250, for example, a card reader, a magnetic card reader, keyboard, a touch screen device, a DNA fingerprint analyzer, a DNA profile analyzer, an optical character reader (OCR), an iris scanner, a retinal scanner, a thumb print reader, a digital camera, a pointing device, such as a mouse, a microphone, an IR remote control, a joystick, a game pad, a personal digital assistant (PDA), a pager, a text messaging device, a smart card reader, an electronic ticket machine or the like. The first identification input component 210 can provide information to the local identification component 230, for example, identifying the person attempting to engage in air travel.

The local identification component 230 can provide at least some of the information associated with person(s) attempting to engage in air travel to an identity transaction engine component (not shown). The identity transaction engine component can then provide security information associated with the person(s) to the local identification component 230 which can be provided to the security output component 240, at an appropriate time (e.g., when a person is participating in a security check). Thus, the location identification system 230 can, at least temporarily, store security information associated with the person(s). This information can be stored, for example, in a security information data store 234.

The local identification component 230 can be coupled to the first identification input component 210 and/or the second identification input 220 by, for example, a telephone connection, a network connection, an extranet, an intranet, the Internet, a satellite link, a wireless communication link, a serial communication link and/or a parallel communication link. Further, the location identification system 230 can be coupled to the identity transaction engine component by, for example, a telephone connection, a network connection, an extranet, an intranet, the Internet, a satellite link, a wireless communication link, a serial communication link and/or a parallel communication link. Information exchanged between the identity transaction engine component and the local identification component 230 can be performed in a variety of secure and/or encrypted manners.

The second identification input component 220 receives at least some of the information associated with the person attempting to engage in air travel. The second identification input component 220 can receive information from input device(s) 260, for example, a card reader, a magnetic card reader, keyboard, a touch screen device, a DNA fingerprint analyzer, a DNA profile analyzer, an optical character reader (OCR), an iris scanner, a retinal scanner, a thumb print reader, a digital camera, a pointing device, such as a mouse, a microphone, an IR remote control, a joystick, a game pad, a personal digital assistant (PDA), a pager, a text messaging device, a smart card reader, an electronic ticket machine or the like. The second identification input component 220 provides at least some of the information received to the local identification component 230. Thereafter, the local identification component 230 provides security information associated with the person received from the identity transaction engine component to the security output component 240 (e.g., from information stored in the security information data store 234).

The security output component 240 provides security information associated with the person attempting to engage in air travel (e.g., to airport security personnel) received from the local identification component 230. The security output component 240 can include output device(s) 270, for example, a telephone, a computer system, a light bar, an audible alarm, a touch screen device, a computer monitor, a television screen, a printer, a personal digital assistant, a wireless telephone display and/or speaker(s).

It is to be appreciated that the system 200, the first identification input component 210, the second identification input component 220, the local identification component 230 and/or the security output component 240 can be component(s) as that term is defined herein.

While the system 200 has been described with regard to airport security, the system 200 can be employed to facilitate security of other types of physical area(s). For example, the system 200 can be employed to secure an airport concourse, an airport terminal, an airport facility (e.g., tarmac and interior), an airport (e.g., physical grounds and interior), building, country, city, county, military base, embassy, cruise ship, hospital, power plant, nuclear facility, train, bridge and/or tunnel in accordance with an aspect of the present invention.

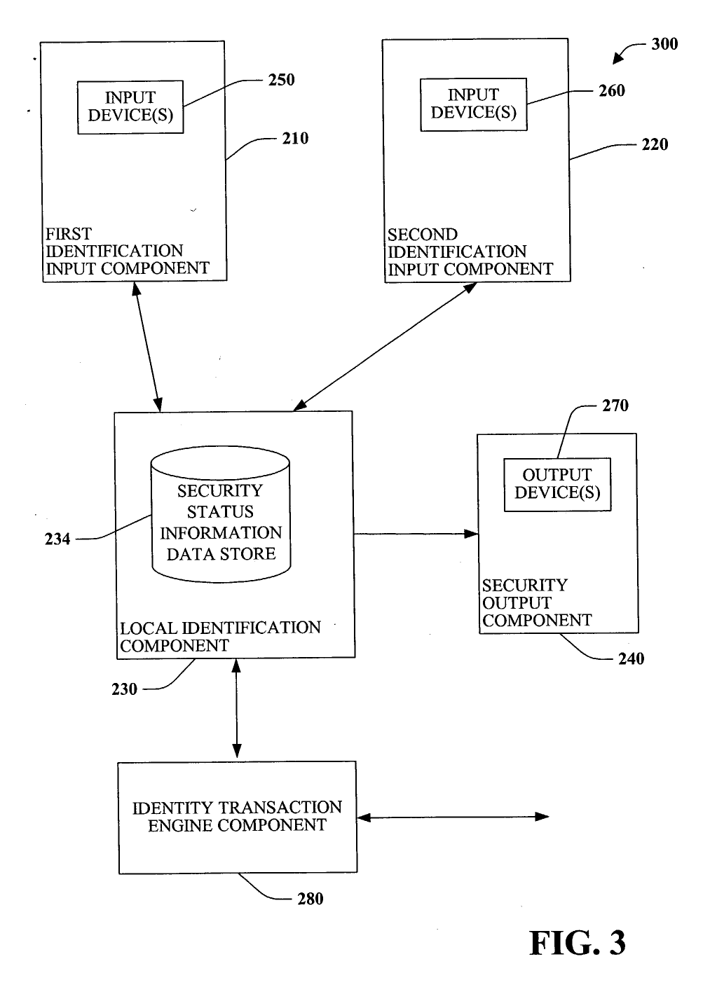

Next, referring to FIG. 3, an airport security system 300 in accordance with an aspect of the present invention is illustrated. The system 300 includes a first identification input component 210, a second identification input component 220, a location identification system 230, a security output component 240 and an identity transaction engine component 280.

The identity transaction engine component 280 can search data store(s) in order to validate identification of the person and/or suitability for air travel based, at least in part, upon information obtained from the local identification component 250. For example, the identity transaction engine component 280 can utilize the person's date of birth, name, Social Security Number, identifier (e.g., identification number), address, age, DNA fingerprint, DNA profile, ethnicity, citizenship, religious affiliation, political affiliation, biometric data, height, weight, health status, gender, registration status with Selective Service, history of conviction of felony and/or inclusion on list(s) of governmental agencies and/or private groups in order to determine whether the person should be permitted to engage in air travel.

The identity transaction engine component 280 can communicate with remote system(s) (not shown) (e.g., data store(s), database(s) and/or data storage system(s)). For example, the identity transaction engine component 280 can search the remote system(s) (not shown) based, at least in part, upon information associated with the person's identity (e.g., name, address, social security number, identification number, passport number, selective service number, voter identification number and/or date of birth) in order to validate and/or verify identity and suitability/eligibility to engage in air travel.

For example, for a person seeking to board an aircraft, the identity transaction engine component can utilize the attribute(s) of a person's DNA fingerprint, name, date of birth and/or age in order to determine whether the person is on a governmental list of suspected terrorists, fleeing felons and/or fugitives from justice. A person on one of these governmental list(s) would be denied permission to board the aircraft.

In another example, attribute(s) of a person can be utilized to determine suitability/eligibility to engage in air travel. For example, legal authorities can identify attribute(s) (e.g., country of origin, height, weight, eye color etc.) of person(s) potentially ineligible for air travel (e.g., airport facilities watching for person city A weighing approximately 155 pounds). Person(s) who possess the attribute(s) would be denied permission to board the aircraft, at least temporarily, until a further security screening can be conducted.

The first identification input component 210 can further include a DNA fingerprint and/or profile analyzer. For example, a DNA sample (e.g., blood, hair and/or skin sample) can be acquired from a person desiring to engage in air travel. A DNA fingerprint and/or profile of the DNA sample can be sent by the DNA fingerprint and or profile analyzer to the identity transaction engine component 280. The identity transaction engine component 280 can analyze the DNA sample and/or compare it to DNA fingerprint and/or profile information stored in data store(s). Thus, based at least in part upon the DNA sample, the identity transaction engine component 280 can determine whether the person is suitable to engage in air travel. The identity transaction engine component 280 can further facilitate determining whether a proposed regulated transaction is logical (e.g., a person boarding an aircraft in New York should not be simultaneously in Seattle).

It is to be appreciated that the system 300 and/or the identity transaction engine component 280 can be component(s) as that term is defined herein.

While the system 300 has been described with regard to airport security, the system 300 can be employed to facilitate security of other types of physical area(s). For example, the system 300 can be employed to secure an airport concourse, an airport terminal, an airport facility (e.g., tarmac and interior), an airport (e.g., physical grounds and interior), building, country, city, county, military base, embassy, cruise ship, hospital, power plant, nuclear facility, train, bridge and/or tunnel in accordance with an aspect of the present invention.

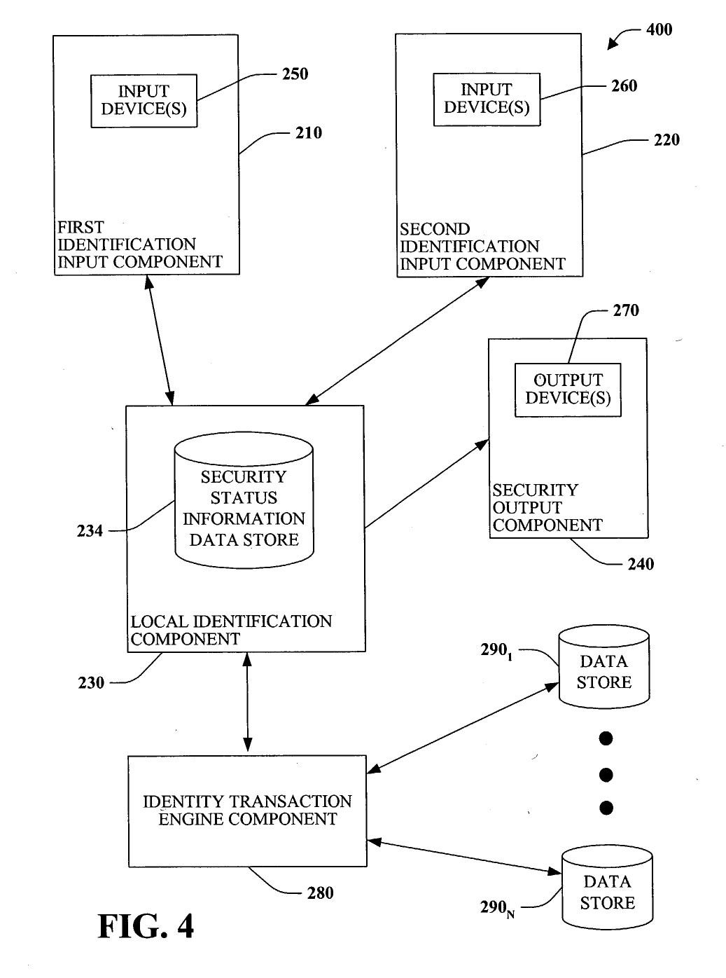

Turning next to FIG. 4, an airport security system 400 in accordance with an aspect of the present invention is illustrated. The system 400 includes a first identification input component 210, a second identification input component 220, a location identification system 230, a security output component 240 and an identity transaction engine component 280. The system 400 further includes a first data store 290₁ through an Nth data store 290_{N}, N being an integer greater than or equal to one. The first data store 290₁ through the N^{th} data store 290_{N} can be referred to collectively as the data store(s) 290.

The data store(s) 290 include information associated with identification of entities (e.g., people). For example, the data store(s) 290 can be governmental (Federal, state, regional and/or local) data store(s) related to, for example, the Social Security Administration, Drivers' license agencies (e.g., Bureau/Department of Motor Vehicles), state identification card issuing agencies, the Selective Service system, the military, voter registration, birth certificates issuing authorities, the Immigration and Naturalization Service, the Justice Department, the Office of Homeland Security, the Bureau of Alcohol, Tobacco and Firearms, the Federal Bureau of Investigation and/or the Central Intelligence Agency. The data store(s) 290 can also include private, non-governmental, data store(s) (e.g., commercial data such as credit record(s)) that can include, for example, a periodically updated copy of governmental data and/or a new set of data about an individual. Additionally, the data store(s) 290 can include DNA information (e.g., collected by governmental and/or private entities) and/or other biometric information. It is to be appreciated that any type of data store(s) suitable for carrying out the present invention can be employed and all such types of data store(s) are intended to fall within the scope of the hereto appended claims.

Information can be stored in the data store(s) 290 in a variety of format(s) including, but not limited to, hierarchical database(s) and/or relational database(s). Information can be stored in the data store(s) 290 in a variety of data structure(s) including, but not limited to, lists, arrays, databases and/or data cubes. For example, information stored in the data store(s) can be text (e.g., alphanumeric), graphical, audio, video and/or digitally stored DNA information. Information can be exchanged between the identification transaction engine component 280 and data store(s) 290 can be performed in a variety of secure and/or encrypted manners. For example, the identity transaction engine component 280 can be coupled to the data store(s) 290 utilizing a high-speed, secure Internet connection.

While the system 400 has been described with regard to airport security, the system 400 can be employed to facilitate security of other types of physical area(s). For example, the system 400 can be employed to secure an airport concourse, an airport terminal, an airport facility (e.g., tarmac and interior), an airport (e.g., physical grounds and interior), building, country, city, county, military base, embassy, cruise ship, hospital, power plant, nuclear facility, train, bridge and/or tunnel in accordance with an aspect of the present invention.

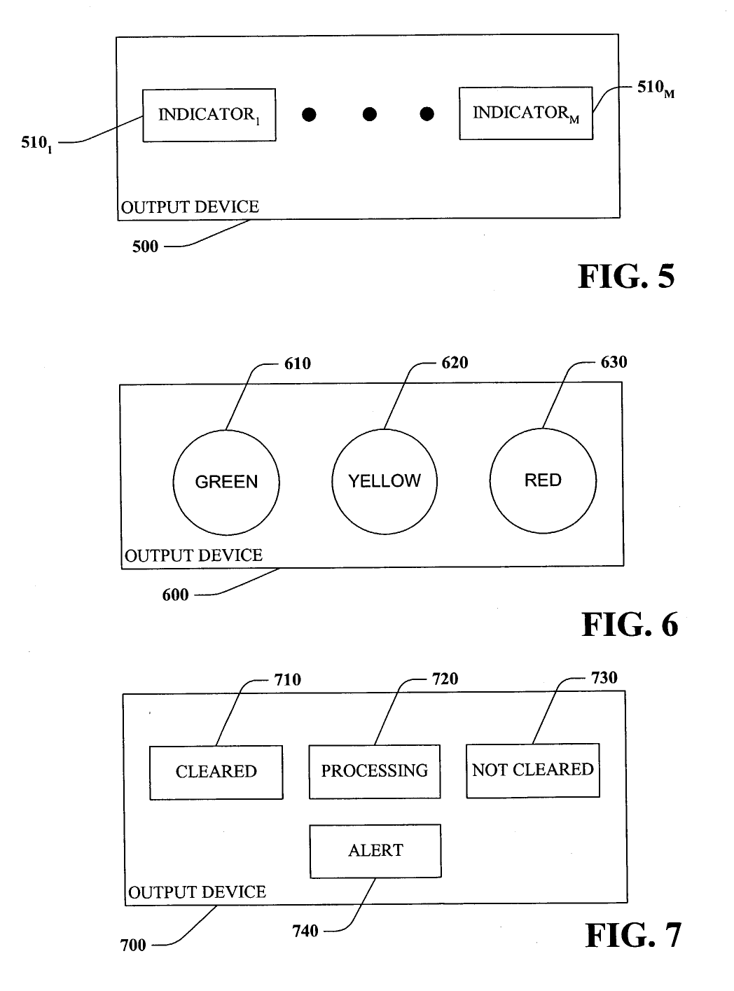

Next, referring to FIG. 5, an exemplary output device 500 in accordance with an aspect of the present invention is illustrated. The output device 500 includes a first indicator 510₁ through an Mth indicator 510_{M}, M being an integer greater than or equal to one. The first indicator 510₁ through the Mth indicator 510_{M} can be referred to collectively as the indicator(s) 510.

The output device 500 facilitates communication of security information received, for example, from an identity transaction engine component 140, identity transaction engine component 280 and/or a local identification component 230. For example, the indicator(s) 510 can include word(s) and/or color(s) to facilitate communication of security information (e.g., red and/or alert to indicate a high-risk prospective air traveler).

Turning briefly to FIG. 6, an exemplary output device 600 in accordance with an aspect of the present invention illustrated. The output device 600 includes a first indicator 610, a second indicator 620 and a third indicator 630.

In this example, the first indicator 610 can be activated (e.g., green light) if security information (e.g., received from an identity transaction engine component 140, identity transaction engine component 280 and/or a local identification component 230) indicates that a person seeking to engage in air travel has been approved for air travel. The second indicator 620 can be activated (e.g., yellow light) if the security information is not yet complete. The third indicator 630 can be activated (e.g., red light) if the security information indicates that the person is high-risk and/or has not been approved for air travel.

Referring next to FIG. 7, an exemplary output device 700 in accordance with an aspect of the present invention is illustrated. The output device 700 includes a first indicator 710, a second indicator 720, a third indicator 730 and a fourth indicator 740.

The first indicator 710 can be activated if a person seeking to engage in air travel has been “cleared” (e.g., approved) for air travel. The second indicator 720 can be activated if security information is not yet complete. The third indicator 730 can be activated if the person seeking to engage in air travel has not been cleared (e.g., not approved) for air travel. The fourth indicator 740 can be activated if the person seeking to engage in air travel is particularly high-risk.

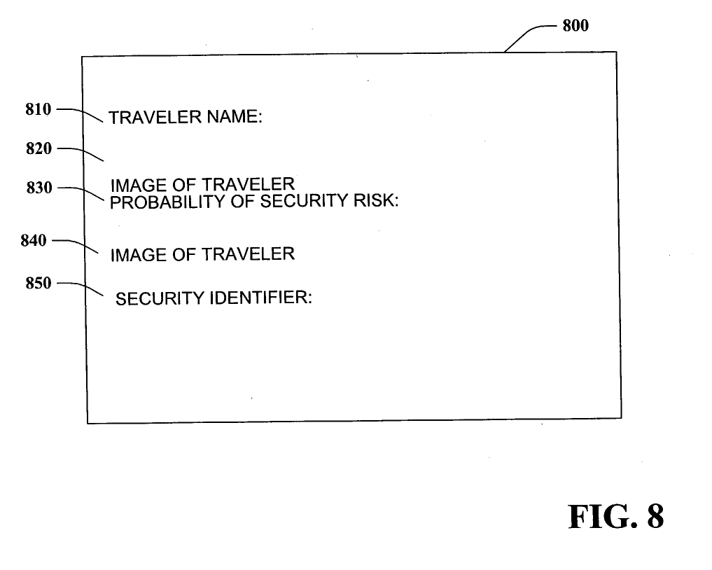

Turning to FIG. 8, an exemplary user interface 800 in accordance with an aspect of the present invention is illustrated. The user interface 800 includes a first field 810, a second field 820, a third field 830, a fourth field 840 and a fifth field 850.

In this example, the first field 810 includes information associated with a traveler's name. The second field 820 includes the traveler's nationality. The third field 830 includes a probability of security risk. The fourth field 840 includes an image of the traveler. The fifth field 850 includes a security identifier (e.g., encoded identifier providing information associated with a security risk of the traveler).

It is to be appreciated that the exemplary user interface 800 is included merely for purposes of illustration and that user interface(s) displaying more or less information is intended to be encompassed by the appended claims.

While the output device 500, the output device 600, the output device 700 and the user interface 800 have been described with regard to airport security, the output device 500, the output device 600, the output device 700 and/or the user interface 800 can be employed to facilitate security of other types of physical area(s). For example, the output device 500, the output device 600, the output device 700 and/or the user interface 800 can be employed to secure an airport concourse, an airport terminal, an airport facility (e.g., tarmac and interior), an airport (e.g., physical grounds and interior), building, country, city, county, military base, embassy, cruise ship, hospital, power plant, nuclear facility, train, bridge and/or tunnel in accordance with an aspect of the present invention.

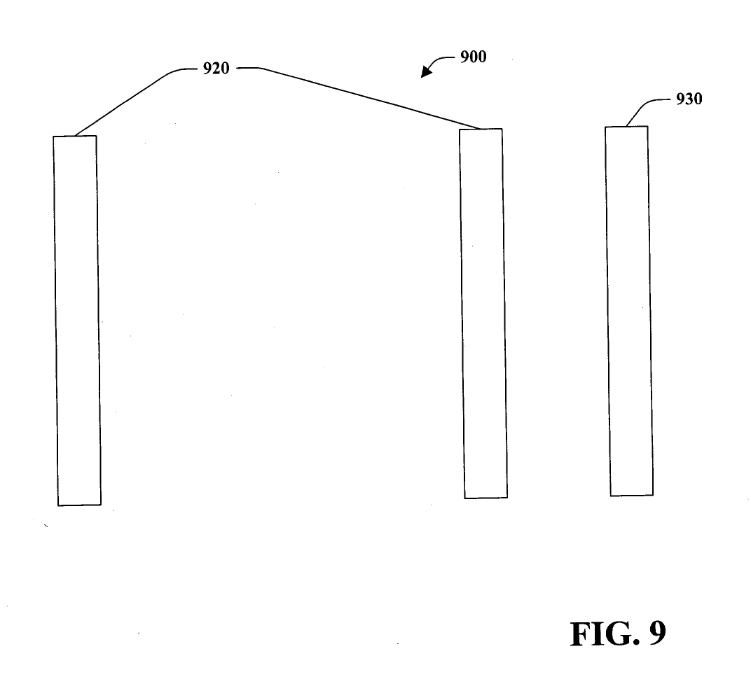

Referring to FIG. 9, an output device 900 in accordance with an aspect of the present invention is illustrated. In this example, the output device 900 can be a component of a security output component 240 and/or a security output component 130. The output device includes means for detaining 920 physically located before a security check point 930. Based, at least in part, upon security information received from a local security system 230 and/or an identity transaction engine component 140, the means for detaining 920 can be activated to detain a person seeking to engage in air travel. For example, the means for detaining 920 can be moveable barriers which are deployed in the event that a high-risk person (e.g., potential terrorist) has been identified by an identity transaction engine component 140 and/or an identity transaction engine component 240. The means for detaining 920 can include, for example, bulletproof glass, metal and/or other material(s) impenetrable by firearms and/or knives. Additionally and/or alternatively, the means for detaining 920 can include means for physically isolating the environment within the means for detaining 920, for example, to protect other person(s) in the airport from substance(s) the person being detained may have on their person and/or to facilitate apprehension of the person being detained.

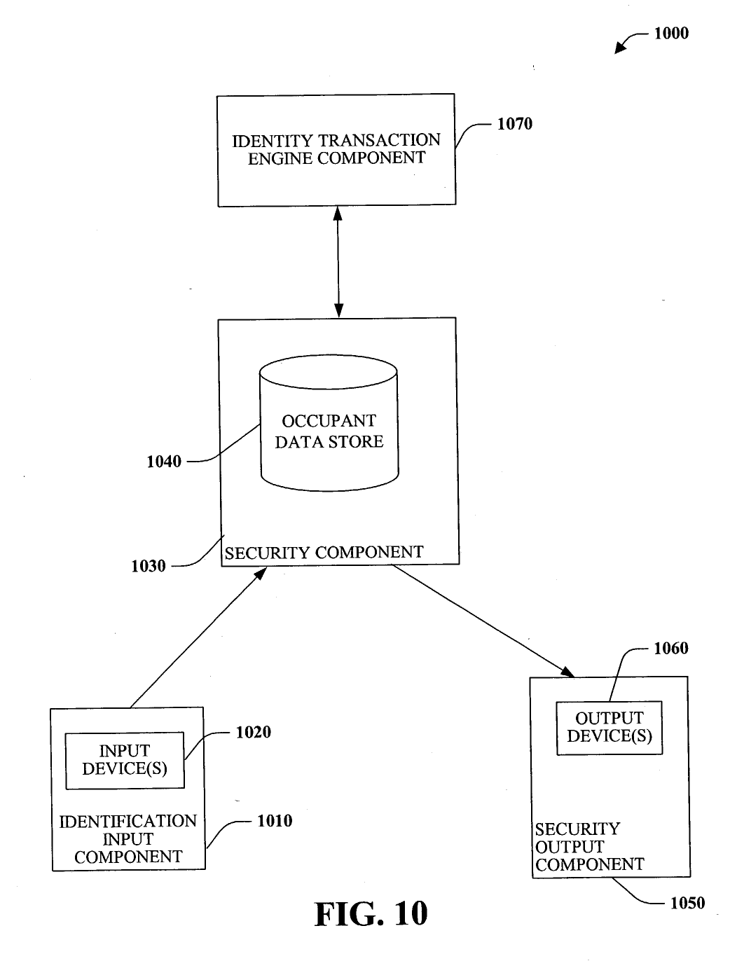

Referring next to FIG. 10, a security system 1000 in accordance with an aspect of the present invention is illustrated. The system 1000 includes at least one identification input component 1010 comprising input device(s) 1020. The system 1000 further includes a security component 1030 having an occupant data store 1040, and, a security output component 1050 having output device(s) 1060. Optionally, the system 1000 can include an identity transaction engine component 1070.

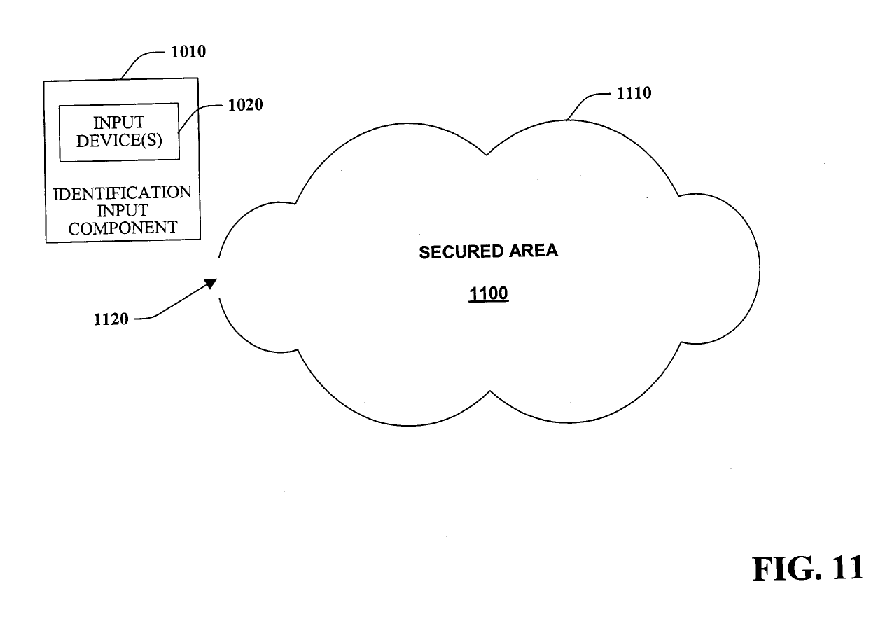

Turning briefly to FIG. 11, a “secured area” 1100 is defined as an area bounded by physical barrier(s) 1110 having entrance(s) 1120 to which access is monitored via identification input component(s) 1010. For example, a secured area can include an airport concourse, an airport terminal, an airport facility (e.g., tarmac and interior), an airport (e.g., physical grounds and interior), building, country, city, county, military base, embassy, cruise ship, hospital, power plant, nuclear facility, train, bridge and/or tunnel.

Referring back to FIG. 10, the system 1000 facilitates security by identifying person(s) located within a secured area. The system 1000 can store identification information associated with person(s) located within the secured area in the occupant data store 1040. For example, the security component 1030 can determine security risk(s) based upon security information associated with person(s) located within the secured area, change(s) associated with person(s) located within the secured area and/or logical inconsistency(ies) (e.g., person(s) exiting system 1000 without having information stored in the occupant data store 1040 and/or person(s) entering the system 1000 without having exited at an appropriate time).

The identification input component 1010 receives information associated with a person attempting to enter, attempting to exit, entering the secured area and/or attempting to exit the secured area and provides at least some of the information received to the security component 1030. The identification input component 1010 can receive information from input device(s) 1020, for example, a card reader, a magnetic card reader, keyboard, a touch screen device, a DNA fingerprint analyzer, a DNA profile analyzer, an optical character reader (OCR), an iris scanner, a retinal scanner, a thumb print reader, a digital camera, a pointing device, such as a mouse, a microphone, an IR remote control, a joystick, a game pad, a personal digital assistant (PDA), a pager, a text messaging device, a smart card reader, electronic ticket machine or the like. The identification input component 1010 can provide information to the security component 1030, for example, identifying the person attempting to enter the secure area and/or entering the secured area.

The identity transaction engine component 1070 can search data store(s) in order to validate identity of the person attempting to enter the secured area, exit the secured area and/or suitability of the person to enter the secured area based, at least in part, upon information obtained from the security component 1030. For example, the identity transaction engine component 1070 can utilize the person's date of birth, name, Social Security Number, identifier (e.g., identification number), address, age, DNA fingerprint, DNA profile, ethnicity, citizenship, religious affiliation, political affiliation, biometric data, height, weight, health status, gender, registration status with Selective Service, history of conviction of felony and/or inclusion on list(s) of governmental agencies and/or private groups in order to determine whether the person presents a security risk to the secured area.

The identity transaction engine component 1070 can communicate with remote system(s) (not shown) (e.g., data store(s), database(s) and/or data storage system(s)). For example, the identity transaction engine component 1070 can search the remote system(s) (not shown) based, at least in part, upon information associated with the person's identity (e.g., name, address, social security number, identification number, passport number, selective service number, voter identification number and/or date of birth) in order to validate and/or verify identity and possession of attribute(s) associated with security risk(s).

The identity transaction engine component 1070 can be coupled to the security component 1030 utilizing, for example, a telephone connection, a network connection, an extranet, an intranet, the Internet, a satellite link, a wireless communication link, a serial communication link and/or a parallel communication link. Information exchanged between the identity transaction engine component 1070 and the security component 1030 can be performed in a variety of secure and/or encrypted manners.

The security output component 1050 provides security risk information associated with the secured area. The security output component 1050 can include output device(s) 1060, for example, a telephone, a computer system, a light bar, an audible alarm, a touch screen device, a computer monitor, a television screen, a printer, a personal digital assistant, a wireless telephone display and/or speaker(s). The security information can provide information and/or instruction(s) to personnel, for example, detain person, conduct thorough search of person(s) in the secured area and/or person(s) in and/or attempting to enter the secured area.

The security output component 1050 can further forward information (e.g., data packet(s)) to other systems (not shown) to provide security information (e.g., including decision(s) of the identity transaction engine component 1070). For example, these other systems can utilize the information provided (e.g., via data packet(s)) to take some predefined further action (e.g., remove passenger baggage from an aircraft).

The identity transaction engine component 1070 utilizes the information received from the security component 1030 to search one or more data store(s) in order to validate identity of the person entering the secured area and/or attempting to enter the secured area. The identity transaction engine component 1070 generates security information associated with the person based, at least in part, upon the information received from the identification input component 1010 and information stored in the data store(s).

The security component 1030 thus receives information from the identification input component 1010 with regard to person(s) entering, attempting to enter, exiting and/or attempting to exit the secured area. The security component 1030 can store information associated with person(s) physically located within the secured area in the occupant data store 1040 received from the identify transaction engine component 1070. In one example, the security component 1030 sends additional request(s) to the identity transaction engine component 1070 to determine whether security risk(s) associated with person(s) physically located within the secured area have changed. In another example, the security component 1030 receives update(s) (e.g., periodic) from the identity transaction engine component 1070 and determines whether security risk(s) associated with person(s) physically located within the secured area have changed.

Based, at least in part, upon information received from the identity transaction engine component 1070 and/or stored in the occupant data store 1040, the security component 1030 determines a security risk associated with the secured area. In one example, the security risk is a Boolean value (e.g., secured or not secured). In another example, the security risk is a probability (e.g., percentage likelihood of security risk). Information associated with the security risk can be communicated to the security output component 1050. The security component 1030 can utilize artificial intelligence technique(s) (e.g., Bayesian learning methods that perform analysis over alternative dependent structures and apply a score, Bayesian classifiers and other statistical classifiers, including decision tree learning methods, support vector machines, linear and non-linear regression and/or neural network) in order to determine the security risk associated with the secured area.

In one example, input device(s) 1020 are located at substantially all entrance/exit point(s) associated with an airport concourse. Each person entering and/or exiting the airport concourse is required to present identification to the system 1000 via the input device(s) 1020. Thus, the security component 1030 is able store security information regarding person(s) physically located within the airport concourse.

In another example, input device(s) 1020 are located at substantially all entrance/exit point(s) associated with the interior of an airport. Each person entering and/or exiting the interior of the airport is required to present identification to the system 1000 via the input device(s) 1020. The security component 1030 can thus track person(s) physically located within the interior of the airport. In a third example, input device(s) 1020 are located at substantially all entrance/exit point(s) associated with the interior of an airport and the airport tarmac. In yet a fourth example, input device(s) 1020 are located at substantially all entrance/exit point(s) associated with an airport.

It is to be appreciated that the system 1000, the identification input component 1010, the security component 1030, the occupant data store 1040, the security output component 1050 and/or the identity transaction engine component 1070 can be component(s) as that term is defined herein.

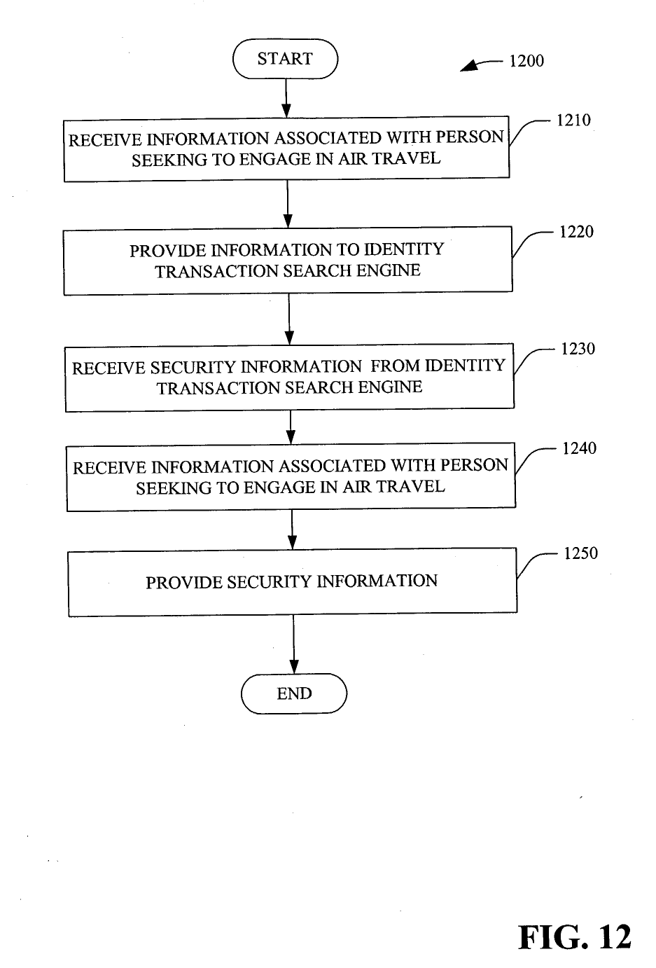

In view of the exemplary systems shown and described above, methodologies that may be implemented in accordance with the present invention, will be better appreciated with reference to the flow charts of FIGS. 12, 13 and 14. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement a methodology in accordance with the present invention. In addition, it will be appreciated that the exemplary methods and other methods according to the invention may be implemented in association with the identification validation system illustrated and described herein, as well as in association with other systems and apparatus not illustrated or described.

The invention may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Turning to FIG. 12, a methodology 1200 for providing airport security in accordance with an aspect of the present invention is illustrated. At 1210, information associated with a person seeking to engage in air travel is received (e.g., from a first identification input component 110 and/or a first identification input component 210). At 1220, the information is provided to an identity transaction search engine (e.g., by a first identification input component 110 and/or a local identification component 230). At 1230, security information is received from the identity transaction search engine (e.g., by a local identification component 230). At 1240, information associated with the person seeking to engage in air travel is received (e.g., from a second identification input component 120 and/or a second identification input component 220). At 1250, security information is provided (e.g., to a security output component 110 and/or a security output component 210).

In one example, the security information comprises conclusory information such as cleared for air travel, not cleared for air travel, detain individual etc. In another example, the security information comprises information associated with a security risk assessment, for example, a probability and/or likelihood that an air traveler is a security risk (e.g., numerical (75%) and/or range-based (e.g., low, medium, high)). In yet another example, security information can further comprise identifying information associated with air traveler(s), for example, digitized fingerprint, digital facial image, digital voice print, etc.

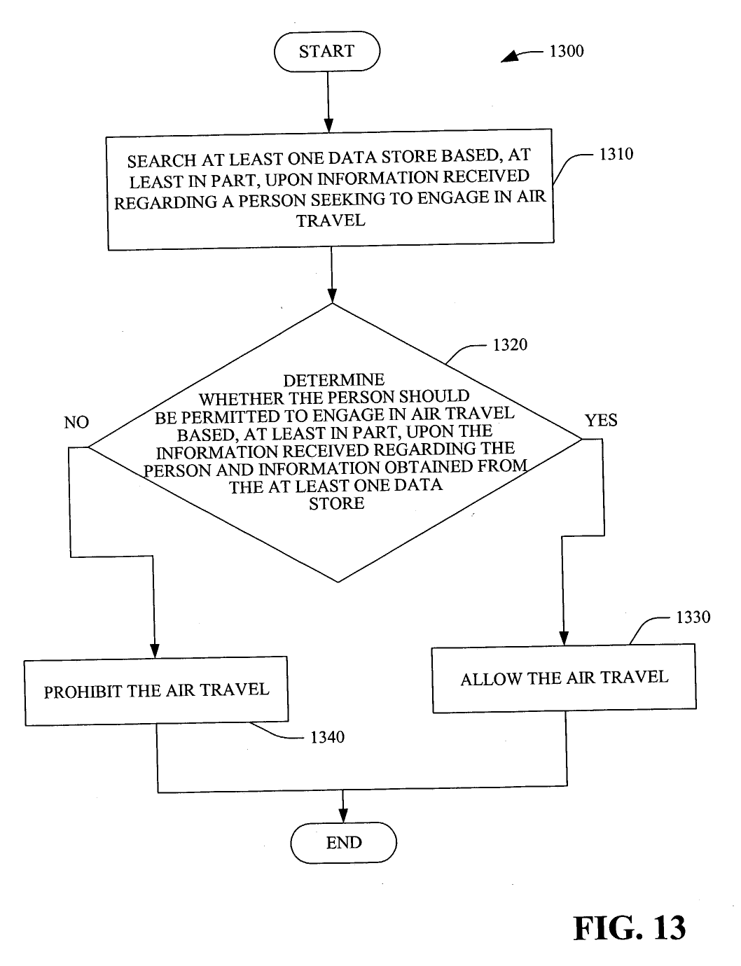

Next, referring to FIG. 13, a methodology 1300 for providing airport security in accordance with an aspect of the present invention is illustrated. At 1310, at least one data store is searched based, at least in part, upon information received regarding a person seeking to engage in air travel. At 1320, a determination is made as to whether the person should be permitted to engage in air travel based, at least in part, upon the information received regarding the person and information obtained from the at least one data store. If the determination at 1320 is YES, at 1330, the air travel is allowed and no further processing occurs. If the determination at 1330 is NO, at 1340, the air travel is prohibited and no further processing occurs.

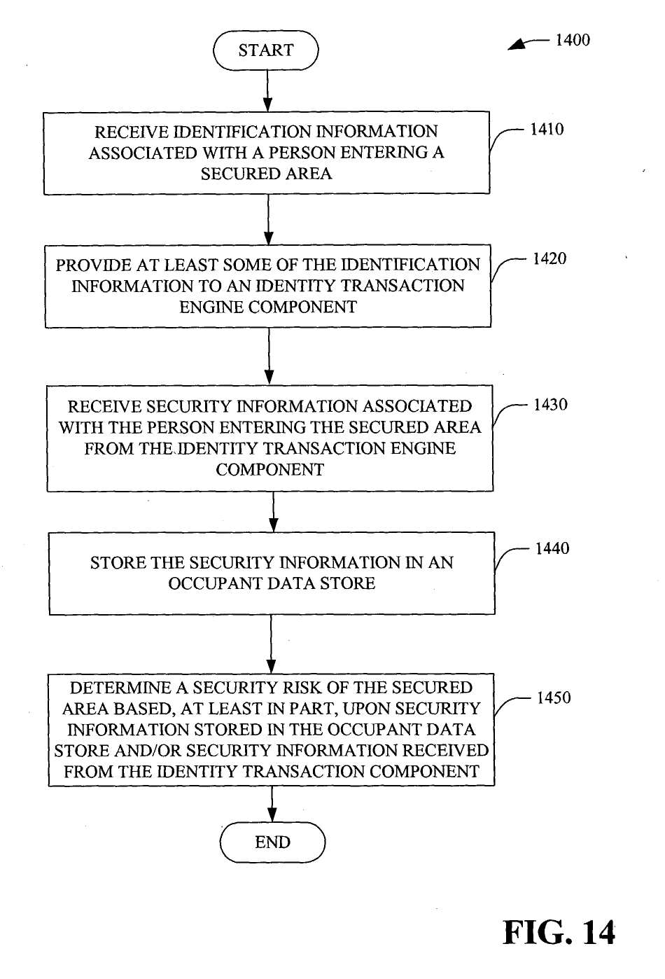

Turning next to FIG. 14, a methodology 1400 for providing security in accordance with an aspect of the present invention is illustrated. At 1410, identification information associated with a person entering a secured area is received (e.g., from an identification input component 1010). At 1420, at least some of the identification information is provided to an identity transaction engine component. At 1430, security information associated with the person entering the secured area is received from the identity transaction engine component. At 1440, the security information is stored in an occupant data store (e.g., occupant data store 1040). At 1050, a security risk of the secured area is determined based, at least in part, upon security information stored in the occupant data store and/or security information received from the identity transaction engine component. For example, artificial intelligence technique(s) (e.g., Bayesian learning methods that perform analysis over alternative dependent structures and apply a score, Bayesian classifiers and other statistical classifiers, including decision tree learning methods, support vector machines, linear and non-linear regression and/or neural network) can be employed in order to determine the security risk associated with the secured area.

Although the invention has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes”, “including”, “has”, “having”, and variants thereof are used in either the detailed description or the claims, these terms are intended to be inclusive in a manner similar to the term “comprising.”

What is claimed is:

1. An airport security system, comprising:
a first identification input component that receives information associated with a person attempting to engage in air travel, the first identification input component providing at least some of the information received to an identity transaction engine component;
a second identification input component that receives at least some of the information associated with the person, the second identification input component providing at least some of the information received to the identity transaction engine component; and,
a security output component that provides security information associated with the person received from the identity transaction engine component.

2. The airport security system of claim 1, further comprising the identity transaction engine component, security information provided by the identity transaction engine component being based, at least in part, upon analysis of the information received from the first identification input component and information stored in at least one data store.

3. The airport security system of claim 1, the at least one data store storing information related to at least one of Social Security records, drivers license records, motor vehicle records, state identification records, military identification records, voter registration records, birth records, passport records, selective service records, national identification records, and work authorization records.

4. The airport security system of claim 1, at least one of the first identification input component and the second identification input component comprising at least one of a card reader, a magnetic card reader, a keyboard, a touch screen device, an optical character reader, an iris scanner, a retinal scanner, a thumb print reader, a digital camera, a pointing device, a microphone, an IR remote control, a joystick, a DNA fingerprint analyzer, a DNA profile analyzer, a game pad, a personal digital assistant, a pager, a text messaging device, a smart card reader and an electronic ticket machine.

5. The airport security system of claim 1, at least one of the first identification input component and the second identification input component coupled to the identity transaction engine component by at least one of a telephone connection, a network connection, an extranet, an intranet, the Internet, a satellite link, a wireless communication link, a serial communication link and a parallel communication link.

6. The airport security system of claim 1, the security output component comprising at least one of a telephone, a computer system, a light bar, an audible alarm, a touch screen device, a computer monitor, a television screen, a printer, a personal digital assistant, a wireless telephone display and a speaker.

7. The airport security system of claim 1, the security information provided by the identity transaction engine component being based, at least in part, upon at least one of the following associated with the person: a DNA profile, a date of birth, name, Social Security Number, identifier, identification number, address, age, ethnicity, citizenship, religious affiliation, political affiliation, health status, failure to have a particular disease, gender, Selective Service registration status, biometric data, height, weight, history of felony conviction, criminal history, inclusion on a list maintained by a governmental agency and inclusion on a list maintained by a private entity.

8. An airport security system, comprising:
a first identification input component that receives information associated with a person attempting to engage in air travel;
a local identification component that receives at least some of the information associated with the person from the first identification input component, the local identification component providing at least some of the information received to an identity transaction engine component, the local identification component further receiving security information associated with the person from the identity transaction engine component;
a second identification input component that receives at least some of the information associated with the person, the second identification input component providing at least some of the information received to the local identification component; and,
a security output component that provides security information associated with the person received from the local identification component based, at least in part, upon security information received from the identity transaction engine component and the information received by the second identification input component.

9. The airport security system of claim 8, further comprising the identity transaction engine component, security information provided by the identity transaction engine component being based, at least in part, upon analysis of the identification information received from the local transaction component and information stored in at least one data store.

10. The airport security system of claim 9, the at least one data store storing information related to at least one of Social Security records, drivers license records, motor vehicle records, state identification records, military identification records, voter registration records, birth records, passport records, selective service records, national identification records, and work authorization records.

11. The airport security system of claim 8, at least one of the first identification input component and the second identification input component comprising at least one of a card reader, a magnetic card reader, a keyboard, a touch screen device, an optical character reader, an iris scanner, a retinal scanner, a thumb print reader, a digital camera, a pointing device, a microphone, an IR remote control, a joystick, a DNA fingerprint analyzer, a DNA profile analyzer, a game pad, a personal digital assistant, a pager, a text messaging device, a smart card reader and an electronic ticket machine.

12. The airport security system of claim 8, at least one of the first identification input component and the second identification input component coupled to the local identification component by at least one of a telephone connection, a network connection, an extranet, an intranet, the Internet, a satellite link, a wireless communication link, a serial communication link and a parallel communication link.

13. The airport security system of claim 8, the security output component comprising at least one of a telephone, a computer system, a light bar, an audible alarm, a touch screen device, a computer monitor, a television screen, a printer, a personal digital assistant, a wireless telephone display and a speaker.

14. The airport security system of claim 8, the security information provided by the identity transaction engine component being based, at least in part, upon at least one of the following associated with the person: a DNA profile, a date of birth, name, Social Security Number, identifier, identification number, address, age, ethnicity, citizenship, religious affiliation, political affiliation, health status, failure to have a particular disease, gender, Selective Service registration status, biometric data, height, weight, history of felony conviction, criminal history, inclusion on a list maintained by a governmental agency and inclusion on a list maintained by a private entity.

15. The airport security system of claim 8, further comprising means for detaining.

16. A method for providing airport security, comprising:
receiving information associated with a person seeking to engage in air travel;
providing at least some of the information to an identity transaction search engine;
receiving security information from the identity transaction search engine;
receiving information associated with the person seeking to engage in air travel; and,
providing security information associated with the person seeking to engage in air travel.

17. The method of claim 16, further comprising at least one of the following acts:
searching at least one data store based at least in part upon the information received regarding the person seeking to engage in air travel;
determining whether the person should be permitted to engage in air travel based, at least in part, upon the identification information and information obtained from the at least one data store;
allowing the air travel if the determination of whether the person should be permitted to in air travel is in the affirmative; and,
prohibiting the air travel if the determination of whether the person should be permitted to engage in air travel is in the negative.

18. A data packet adapted to be communicated between two or more computer processes, the data packet comprising:
security information associated with a person seeking to engage in air travel, the security information being based, at least in part, upon information received from a identity transaction engine component and the information received by the second identification input component.

19. A computer readable medium having computer usable instructions for an airport security system, comprising:
a first identification input component that receives information associated with a person attempting to engage in air travel, the first identification input component providing at least some of the information received to an identity transaction engine component;
a second identification input component that receives at least some of the information associated with the person, the second identification input component providing at least some of the information received to the identity transaction engine component; and,
a security output component that provides security information associated with the person based, at least in part, upon information received from the identity transaction engine component and the information received by the second identification input component.

20. An airport security system, comprising:
means for receiving information associated with a person attempting to engage in air travel;
means for providing the information to an identity transaction engine component;
second means for receiving at least some of the information associated with the person;
means for providing the at least some of the information received to the identity transaction engine component; and,
means for providing security information associated with the person based, at least in part, upon information received from the identity transaction engine component and the second means for receiving at least some of the information associated with the person.

21. A security system comprising:
an identification input component that receives identification information associated with a person entering a secured area,
a security component that receives the identification information from the identification input component, provides at least some of the identification information to an identity transaction engine component, receives security information associated with the person entering the secured area from the identity transaction engine component, and, determines a security risk of the secured area based, at least in part, upon security information received from the identity transaction engine component; and,
a security output component receives information associated with the security risk from the security component.

22. The system of claim 21, where the security component stores the security information in an occupant data store, and, further determines the security risk based, at least in part, upon security information stored in the occupant data store.

23. The system of claim 21, further comprising the identity transaction engine component.

24. A method for providing security for a secured area comprising:
receiving identification information associated with a person;
providing at least some of the identification information to an identity transaction engine component;
receiving security information associated with the person from the identity transaction engine component; and,
determining a security risk of the secured area based, at least in part, upon information received from the identity transaction engine component.

25. The method of claim 24, further comprising storing the security information in an occupant data store.

26. The method of claim 25, determining a security risk of the secured area being further based, at least in part, upon information stored in the occupant data store.
